(19) United States
(12) Patent Application Publication
(10) Pub. No.: US 2025/0285180 A1
(43) Pub. Date: Sep. 11, 2025

(54) Methods and Systems for Managing Retirement Asset Transfer within a Private Blockchain Network

(71) Applicant: TEACHERS INSURANCE AND ANNUITY ASSOCIATION OF AMERICA, New York, NY (US)

(72) Inventors: Srinivasa Vara Prasad Krishnamsetty, Concord, NC (US); Vamsi Pola, Concord, NC (US); Shashank Kandarpa Venkata, Weehawken, NJ (US); Tasneem Hajara, Hillsborough, NJ (US); Sastry Vsm Durvasula, Phoenix, AZ (US)

(21) Appl. No.: 18/599,114

(22) Filed: Mar. 7, 2024

(51) Int. Cl. G06Q 40/04; G06Q 20/06; G06Q 20/38; G06Q 20/40

(52) U.S. Cl. CPC G06Q 40/04; G06Q 20/06; G06Q 20/3829; G06Q 20/405

(57) ABSTRACT

System, method, and apparatus for managing retirement asset transfers within a private blockchain network are provided. The method may comprise processing various input event by a destination node. The input events may include a transaction request received input event, a transfer requested input event, a transfer approved input event, an asset sent input event, an asset received input event, and a transaction closed input event.

### TECHNICAL FIELD

The present disclosure relates to managing retirement asset transfers within a private blockchain network, and, more particularly, to managing retirement asset transfers within a private blockchain network in a secure, efficient manner while maintaining data privacy.

### BACKGROUND

Clients may need to transfer assets between different financial institutes at various life stages. Transferring funds between different retirement accounts, e.g., a rollover, is a typical scenario. Rollovers are subject to complex rules and regulations that vary depending on the type of accounts involved, the source and destination of the funds, and the timing and frequency of the transactions. Rollovers can also have significant tax implications for the account holders, depending on their eligibility and compliance with applicable laws.

Conventional rollover processing is inefficient, error-prone, and time-consuming. Such rollover processing typically requires manual intervention from multiple parties, such as account holders, financial institutions, plan administrators, and tax authorities. Conventional rollovers also involve multiple steps, such as verifying account information, validating rollover eligibility, initiating and confirming fund transfers, reporting and documenting transactions, and updating account balances and statuses. These steps can result in delays, errors, inconsistencies, and disputes that can affect the quality and accuracy of the rollover process and the satisfaction of the account holders. Furthermore, conventional rollovers are operated and managed by multiple financial institutions that each have their own incompatible and proprietary rollover computing resources, that are not interoperable and are subject to computer tampering or other attacks. Managing this complexity requires investment of great expense and time by financial institutions.

Therefore, there is a need for improved platforms and technologies for facilitating rollover processes in a simple, fast, and secure manner.

### SUMMARY

One exemplary embodiment of the present disclosure may be a computer-implemented method for managing retirement asset transfers within a private blockchain network. The method may comprise: (i) processing, by a destination node associated with a destination entity, a transaction request received input event by: generating a transfer request based on the transaction request, causing a transfer document to be generated, transmitting, to a source node associated with a source entity, the transfer request and the transfer document, and updating a current transfer state to transfer requested; (ii) processing, by the destination node, a transfer requested input event by: receiving, from the source node, a message indicating that transaction request is approved, and updating the current transfer state to transfer approved; (iii) processing, by the destination node, a transfer approved input event by: receiving a message indicating that the source entity has sent the retirement asset to the destination entity, and updating the current transfer state to asset sent; (iv) processing, by the destination node, an asset sent input event by: confirming that the destination entity has received the retirement asset, and updating the current transfer state to asset received; (v) processing, by the destination node, an asset received input event by: confirming that the retirement asset has been added to an electronic account of a user associated with the transaction request, and updating the current transfer state to closed; and (vi) processing, by the destination node, a transaction closed input event by transmitting, to a user device, a notice of receipt of the retirement asset.

Another exemplary embodiment of the present disclosure may be a computer system for managing retirement asset transfers within a private blockchain network. The system may include: a destination node; and a source node, wherein the blockchain network is maintained by a plurality of nodes including the destination node associated with a destination entity and the source node associated with a source entity. The destination node may include: one or more processors; and a memory having stored thereon a set of computer-executable instructions that, when executed by the processors, cause the processors to: (i) receive, by the destination node, an input event corresponding to a transaction request of transferring a retirement asset from the destination entity to the source entity, wherein the input event includes a current transfer state corresponding to one of a plurality of transaction states, and wherein the current transfer state corresponds to the transaction request of the retirement asset; (ii) until the current transfer state is transaction closed: process, via one or more processors of the destination node, the input event to determine the current transfer state; (a) when the current transfer state is transaction request received: generate a transfer request based on the transaction request, cause a transfer document to be generated, transmit, to the source node, the transfer request and the transfer document, and update the current transfer state to transfer requested, (b) when the current transfer state is transfer requested: receive, from the source node, a message indicating that transaction request is approved, and update the current transfer state to transfer approved, (c) when the current transfer state is transfer approved: receive a message indicating that the source entity has sent the retirement asset to the destination entity, and update the current transfer state to asset sent, (d) when the current transfer state is asset sent: confirm that the destination entity has received the retirement asset, and update the current transfer state to asset received, (e) when the current transfer state is asset received: confirm that the retirement asset has been added to an account of a user associated with transaction request, and update the current transfer state to closed, and (iii) when the current transfer state is transaction closed: transmit, to a user device, a notice of receipt of the retirement asset.

Yet another exemplary embodiment of the present disclosure is a computer readable storage medium having stored thereon a set of non-transitory computer readable instructions. The set of non-transitory computer readable instructions, when executed, may cause a destination node within the blockchain network to: (i) receive, by the destination node, an input event corresponding to a transaction request of transferring a retirement asset from the destination entity to the source entity, wherein the input event includes a current transfer state corresponding to one of a plurality of transaction states, and wherein the current transfer state corresponds to the transaction request of the retirement asset; (ii) until the current transfer state is transaction closed: process, via one or more processors of the destination node, the input event to determine the current transfer state; (a) when the current transfer state is transaction request received: generate a transfer request based on the transaction request, cause a transfer document to be generated, transmit, to the source node, the transfer request and the transfer document, and update the current transfer state to transfer requested, (b) when the current transfer state is transfer requested: receive, from the source node, a message indicating that transaction request is approved, and update the current transfer state to transfer approved, (c) when the current transfer state is transfer approved: receive a message indicating that the source entity has sent the retirement asset to the destination entity, and update the current transfer state to asset sent, (d) when the current transfer state is asset sent: confirm that the destination entity has received the retirement asset, and update the current transfer state to asset received, (e) when the current transfer state is asset received: confirm that the retirement asset has been added to an account of a user associated with transaction request, and update the current transfer state to closed, and (iii) when the current transfer state is transaction closed: transmit, to a user device, a notice of receipt of the retirement asset.

### BRIEF DESCRIPTION OF THE DRAWINGS

The figures described below depict various aspects of the system and methods disclosed therein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 depicts an exemplary computing environment in which various embodiments of the present disclosure may be implemented.

FIG. 2A depicts an exemplary graphical user interface (GUI) that may be displayed on a computing device, in accordance with various embodiments described herein.

FIG. 2B depicts an exemplary GUI similar to FIG. 2A, but in which the user has submitted a transaction request.

FIG. 3A depicts an exemplary rollover blockchain ledger in accordance with various embodiments described herein.

FIG. 3B depicts an exemplary rollover blockchain ledger similar to FIG. 3A, in which details of different blocks are shown.

FIG. 4A is an example state diagram that illustrates a method for transferring assets within a blockchain network according to some embodiments disclosed herein.

FIG. 4B is an example sequence diagram that illustrates a process for updating a state of a transaction.

FIG. 5A is an example sequence diagram that illustrate a method for registering a node into a consortium blockchain network according to some embodiments disclosed herein.

FIG. 5B is an example sequence diagram following the sequence diagram of FIG. 5A.

FIG. 6 depicts example permission levels of different nodes according to some embodiments disclosed herein.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

### Overview

The disclosure provides a method and system for performing asset transfers (e.g., rollovers) between different entities in a blockchain network.

As used herein, the term “assets” may refer to government-issued currencies (such as U.S. dollars), cryptocurrencies (such as Bitcoin), and/or capital assets such as stocks, and certificates of deposit (CDs).

As used herein, the term “destination entity” may refer to a transferee entity in a retirement asset transfer request. The term “destination node” refers to a blockchain node associated with a destination entity. The term “source entity” may refer to a transferor entity in a retirement asset transfer request. The term “source node” refers to a blockchain node associated with a source entity. It should be understood that the terms source entity, source node, destination entity, and destination node are defined with respect to a retirement asset transfer request. Accordingly, in some aspects, a destination node with respect to one retirement asset transfer request may be a source node with respect to another retirement asset transfer request. When multiple transactions are performed simultaneously, a given node may be both a source node and a destination node at the same time, with respect to different transaction.

A blockchain network may achieve a distributed consensus on the validity or invalidity of information. As opposed to using a central authority, a blockchain ledger is a distributed database or ledger, in which a transactional record is maintained at each node of a peer-to-peer network. Commonly, the distributed ledger is comprised of groupings of transactions bundled together into a block. When a change to the distributed ledger is made (e.g., when a new transaction and/or block is created), each node must form a consensus as to how the change is integrated into the distributed ledger. Upon consensus, the agreed upon change is propagated to each node via a blockchain network so that each node maintains an identical copy of the updated distributed ledger. Nodes within the blockchain network ignore any change that does not achieve a consensus. Accordingly, unlike a traditional system which uses a central authority, a single party cannot unilaterally alter the distributed ledger. Because past transactions are immutable, blockchain technologies are generally described as providing a trusted and secure source of information.

The present techniques leverage the secure features of blockchain networks to perform transactions in a secure, tamper-resistant manner. More specifically, the present techniques provide a private blockchain network, in which a plurality of nodes that maintain a ledger and include respective smart contracts. The smart contracts may include instructions for processing transaction requests, such as generating transfer documents and requests, verifying transfer documents and request, determining transaction results, and/or executing transaction requests based on determined transaction results. The respective nodes execute the smart contracts when condition(s) are met. For example, conditions may include receiving a transaction request from a user device, verifying a transfer document successfully, etc. Thus, the overall process is highly automated and much faster than the conventional manner for processing transaction requests.

When executing the instructions in the smart contracts, a node may digitally sign transfer documents, transaction requests, and/or transaction results, enabling other node(s) to verify the transfer documents, transaction requests, and/or transaction results by authenticating the digital signatures. The private blockchain network may be configured to require that for each transaction to be executed successfully, the nodes in the blockchain network must reach a consensus. Consensus may be reached via independent verification of the transaction request by each node according to one or more predetermined consensus mechanisms, as discussed herein. After executing the transaction by including it into a block in the rollover blockchain ledger, the transaction records cannot be changed. Thus, the transaction processing is protected against fraudulent actions and data tampering, whether intentional or not.

In some embodiments, the blockchain network may be a permissioned network, in which each node may have different permission levels with respect to different blocks or transactions. Nodes may be required to register with the blockchain network before being allowed to participate. In this way, data privacy is greatly preserved for the user and all entities in the blockchain network.

### Exemplary Computing System

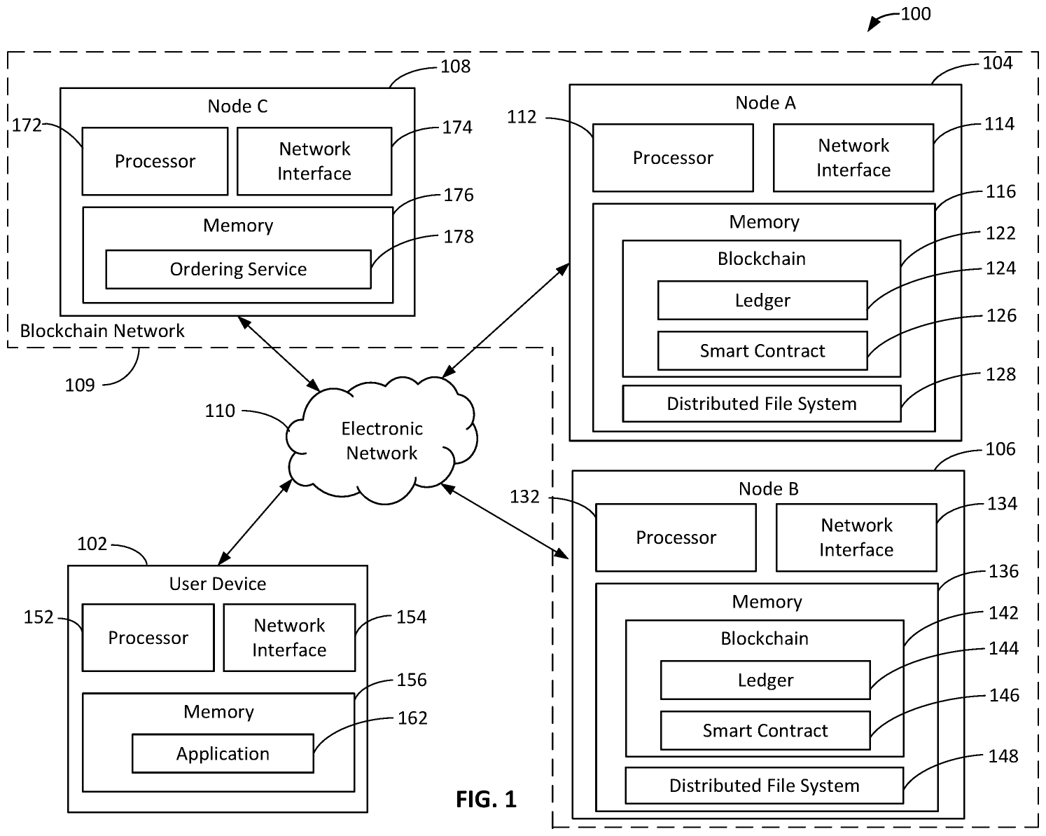

FIG. 1 depicts a block diagram of an exemplary computing environment 100 in which a method for transferring assets within a blockchain network may be performed, in accordance with various aspects discussed herein. The environment 100 includes a user device 102, a node A 104, a node B 106, a node C, a node C 108 and an electronic network 110. The user device 102, the node A 104, and the node B 106 may be communicatively coupled via the electronic network 110. The node A 104, the node B 106, the node C 108, and optionally other nodes (not depicted) may be nodes registered with a blockchain network 109.

In some embodiments, the user device 102 may connect to the blockchain network 109 indirectly. That is, the user device 102 may use an API (such as the application 162) to connect to the blockchain network 109. For example, the API may package the messages (e.g., transaction proposals) that the user device 102 attempts to send to the blockchain network 109 in a properly architected format. The API may then transmit the packaged messages to a target node in the blockchain network 109.

In some embodiments, the user device 102 may connect to the electronic network 110 indirectly. That is, there may be intermediate software layers or hardware components. Such intermediate software layers may include a virtual private network (VPN) software. Such intermediate hardware components may be an intermediate device that provides Bluetooth signals, Wi-Fi signals, personal hotspot signals, or other signals. In this way, the user device 102 may connect to the intermediate device directly, and through the intermediate device, connect to the major electronic network 110 indirectly.

In some embodiments, the user device 102 may not connect to the blockchain network 109 or the electronic network 110. In such scenarios, the user device 102 may not transmit and receive messages from the blockchain nodes. The user device 102 may have cached thereon the information of past or present transactions. A user may view the status of the past or present transactions as of the time immediately before the user device 102 being disconnected to the networks using the cached information.

The network 110 may be a single communication network (e.g., the Internet), and in some implementations also includes one or more additional networks. As just one specific example, the network 110 may include a cellular network, the Internet, and a server-side local area network (LAN). While FIG. 1 shows only a single user device 102, it is understood that the environment 100 may include any suitable number of similar user devices operating according to the principles disclosed herein.

Generally, the user device 102 may be configured to obtain information from a user, generate transaction requests for the user, submit requests to the blockchain network 109, and receive messages from the blockchain network 109. The user device 102 may be any suitable device, including one or more computers, laptops, mobile devices, wearables, and/or other electronic or electrical component. The user device 102 includes a processor 152, a network interface 154, memory 156, and a network interface 154.

The processor 152 may be a single processor (e.g., a central processing unit (CPU)), or may include a plurality of processors (e.g., one or more CPUs, one or more graphics processing units (GPUs), a combination of one or more CPUs and one or more GPUs, etc.).

The network interface 154 includes hardware, firmware, and/or software configured to enable the user device 102 to exchange electronic data with the node A 104, the node B 106, and other computing devices via the network 110. For example, the network interface 154 may include a wired or wireless router and a modem.

The memory 156 is a computer-readable, non-transitory storage unit, device or medium, or collection of units/devices, that may include persistent and/or non-persistent memory components. The memory 156 may include sets of computer-executable instructions for performing functions within the environment 100. The memory 116 may include an application module 162 comprising a set of computer-executable instructions for receiving transaction request from a user and transmitting the transaction request to the node A 104. In some embodiments, the application may be constructed using the techniques of Hyperledger Fabric, Corda, or Quorum.

The blockchain network 109 is a technical infrastructure that provides distributed ledger and smart contract services. In some embodiments, the blockchain network may be constructed using the techniques of Hyperledger Fabric, Corda, or Quorum. The node A 104, the node B 106, node C, and optionally other nodes (not depicted) may compose nodes of the blockchain network 109. The blockchain network 109 may be a consortium blockchain network. That is, the network may be private and accessible to a plurality of preselected/pre-screened nodes only, which may include the node A 104 and the node B 106.

A blockchain channel may be set up and maintained via the blockchain network 109. The blockchain channel is a mechanism that provides a private layer of communication. The blockchain channel is defined by a set of machine-readable channel configurations. The channel configurations may include machine-readable policy parameters and network parameters. The policy parameters may define which entity(ies) are in the consortium, the permission levels of the nodes of the respective entities, the criteria for allowing a new entity to join the consortium and determining its corresponding permission level, the process of proposing and approving a transaction, and/or the process of creating and adding a new block to the rollover blockchain ledger.

Further, the policy parameters may define one or more consensus mechanisms used by the blockchain network, which may include (i) a proof-of-work consensus mechanism, (ii) a proof-of-stake consensus mechanism, (iii) a proof-of-authority consensus mechanism, and (iv) other mechanisms such as Raft, Practical Byzantine Fault Tolerance (PBFT), Istanbul Byzantine Fault Tolerant (IBFT), and Kafka.

In the proof-of-work mechanism, a plurality of mining nodes (or “miners”) compete to solve a mathematical problem. The mining node that solves the mathematical problem first may create a new block. The solution to the mathematical problem is the mining node's proof of work that makes creation of the new block legitimate. The mining node that solves the mathematical problem is rewarded by a token that has value within the network.

In the proof-of-stake mechanism, a plurality of validating nodes (or “validators”) holds asset tokens as its proof of stakes. When validating node creates a new block, the validating node's asset tokens are locked as collateral. If the new block is later determined as invalid, the validating node will lose its collateral.

In the proof-of-authority mechanism, an ordering node may be predetermined to be trustworthy and issued with a certificate authority. The certificate authority is the ordering node's proof of authority that allows the ordering node to create a new, legitimate block. Advantageously, using a proof-of-authority mechanism in a private blockchain network saves a substantial amount of computing resources compared to the work-of-proof mechanism, and maintains the security of the transactions because all nodes in the private blockchain network are preselected and trustworthy. The present-techniques may use any of the consensus mechanisms described above, and/or any later developed.

The network parameters may define the hardware, software, and/or communication protocols used by the nodes. The communication protocols provide a set of rules based on which the blockchain nodes exchange messages. For example, the set of communication protocols may provide how nodes authenticate identity of each other, how the nodes authenticate messages from each other, how to encrypt and decrypt messages, etc. The nodes may communicate in the blockchain channel (i.e., “on-channel communications”) using the communication protocols. In contrast, because the user device 102 is not a node in the blockchain network 109, the user device 102 may not be able to use such communication protocols to communicate with the blockchain nodes directly (i.e., the blockchain network 109 may not support off-channel communications). In such scenarios, the user device 102 may have installed thereon (e.g., in the memory of the user device 102) an application dedicated to communicating with the blockchain network 109. For example, the application may convert an original message generated by the user device 102 to a modified message that is compatible with the blockchain communication protocols. Additionally or alternatively, the user device 102 may use a third-party service (such as a blockchain oracle) to communicate with the blockchain network 109.

### Exemplary Blockchain Nodes

As described above, the node A 104 and the node B 106 are nodes in the blockchain network 109. As discussed, each blockchain node may be located on a computing device that participates in a blockchain network by running the protocol software and keeping a copy of a shared ledger maintained by the blockchain network. The node A 104 and the node B 106 are peer nodes associated with respective entities, which may differ. The entities may take actions with respect to the blockchain network 109 via their respective peer nodes.

The node A 104 is a computing device associated with an entity A. The node A 104 includes a processor 112, a network interface 114, and memory 116. The processor 112 may be a single processor (e.g., a central processing unit (CPU)), or may include a plurality of processors (e.g., one or more CPUs, one or more graphics processing units (GPUs), a combination of one or more CPUs and one or more GPUs, etc.).

The network interface 114 includes hardware, firmware, and/or software configured to enable the node A 104 to exchange electronic data with the user device 102, the node B 106, and other computing devices via the network 110. For example, the network interface 114 may include a wired or wireless router and a modem. The node A 104 may include one or more servers, for example, which may reside at a single location or multiple locations.

The memory 116 is a computer-readable, non-transitory storage unit or device, or collection of units/devices, that may include persistent and/or non-persistent memory components. The memory 116 may include a blockchain module 122 and a distributed file system module 128, each comprising a set of computer-executable instructions that may be executed by the processor 112. The blockchain module 122 is a software module for performing actions in the blockchain network 109. The distributed file system module 128 is a software module for storing and managing documents.

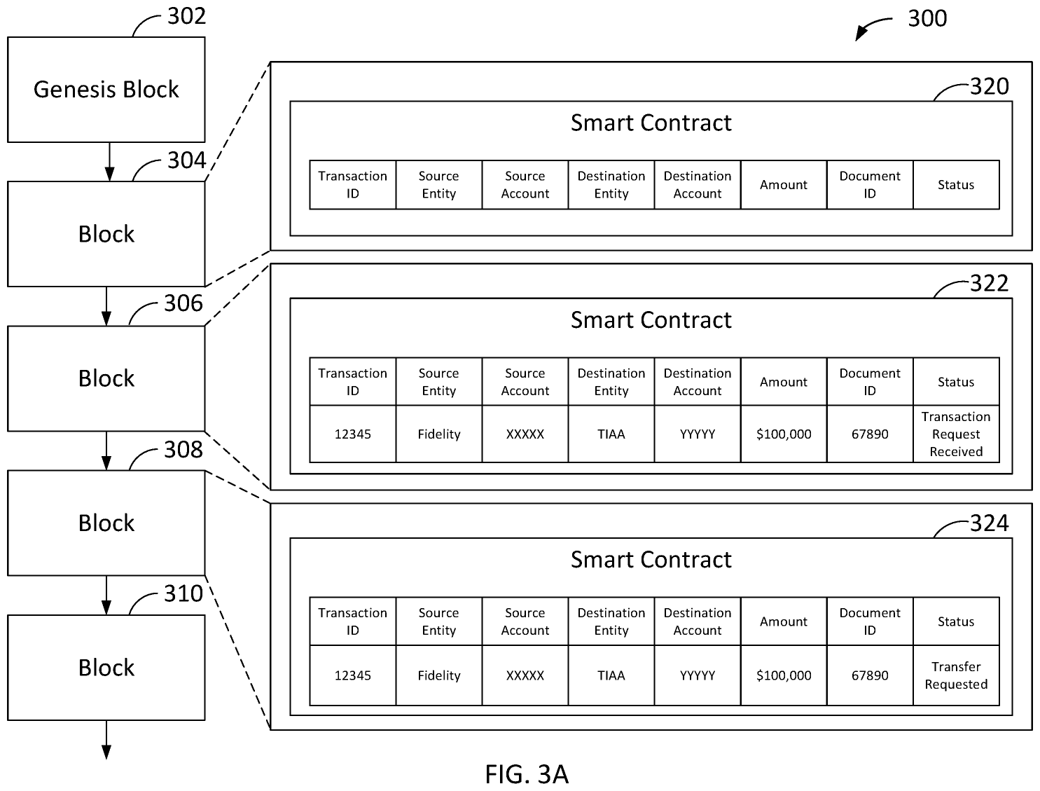

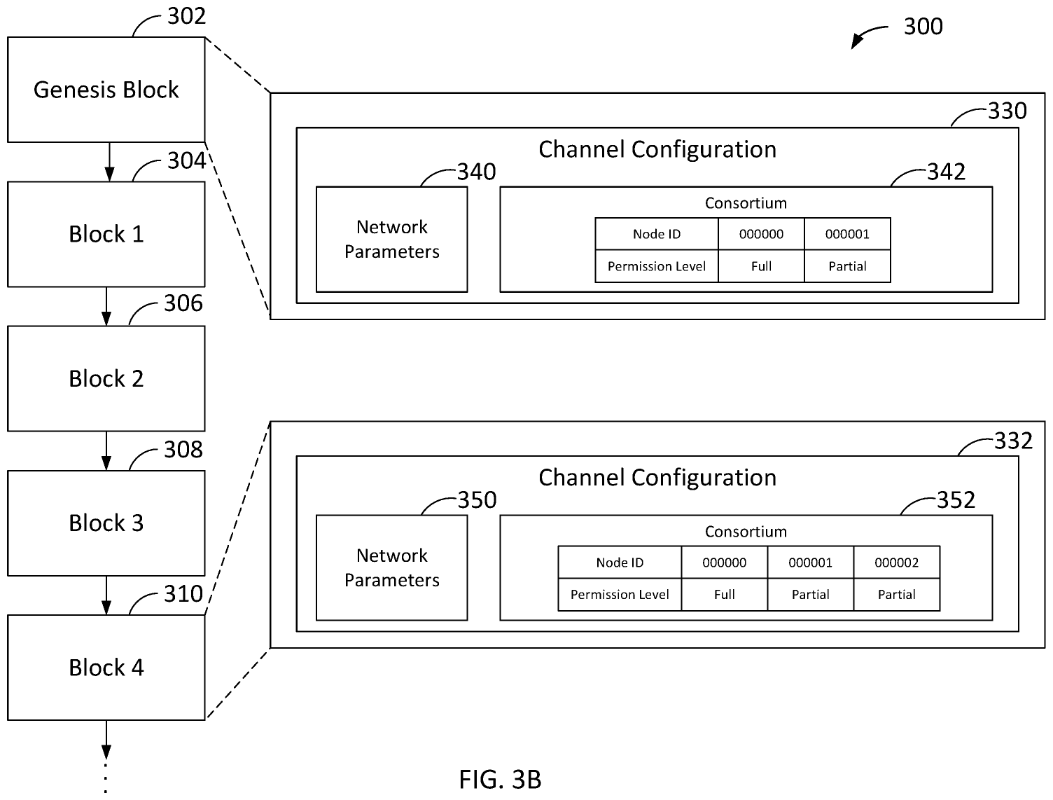

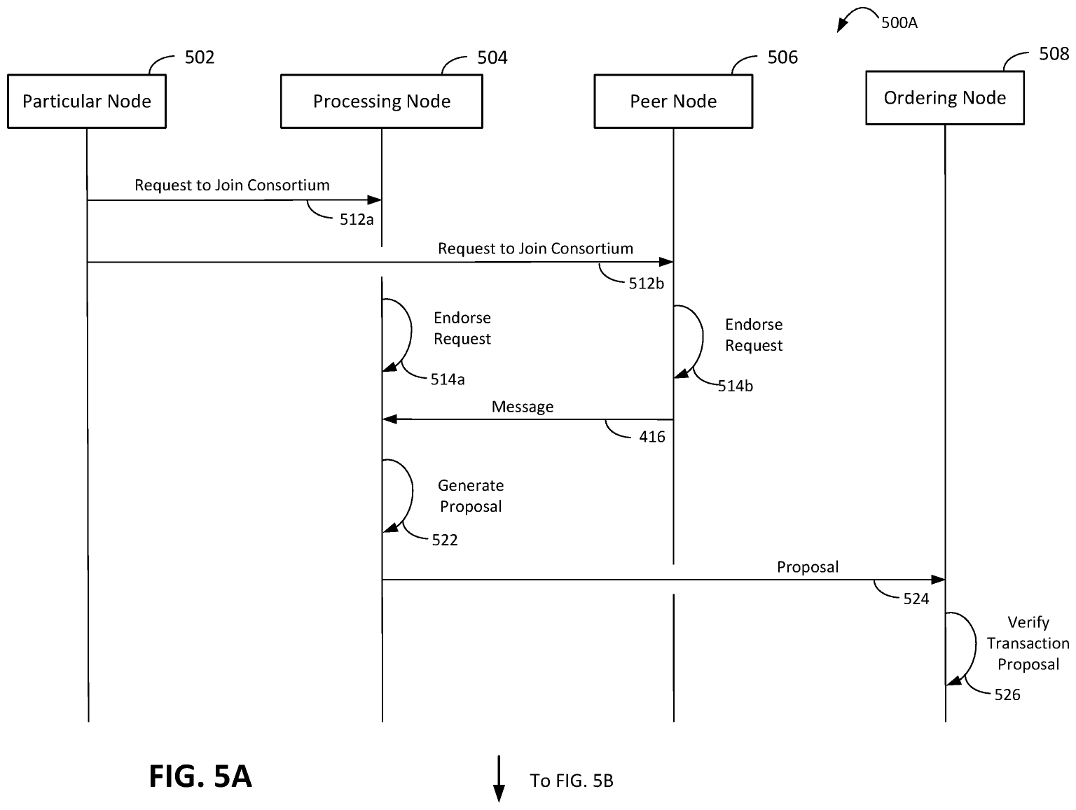

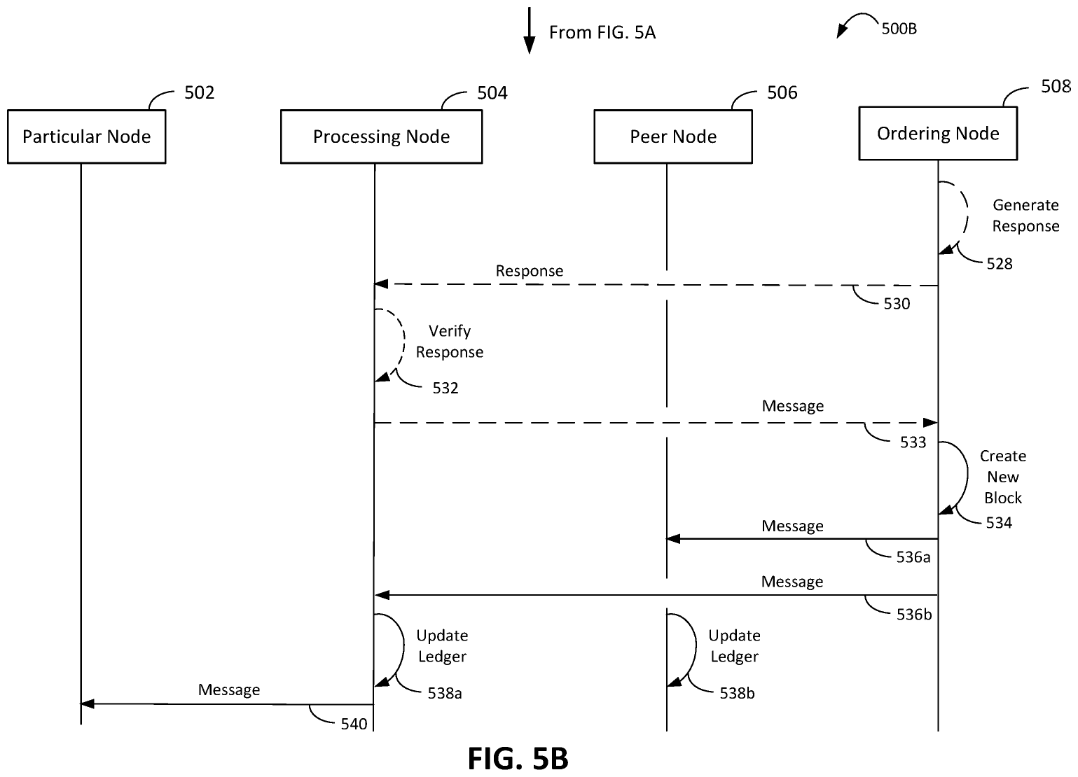

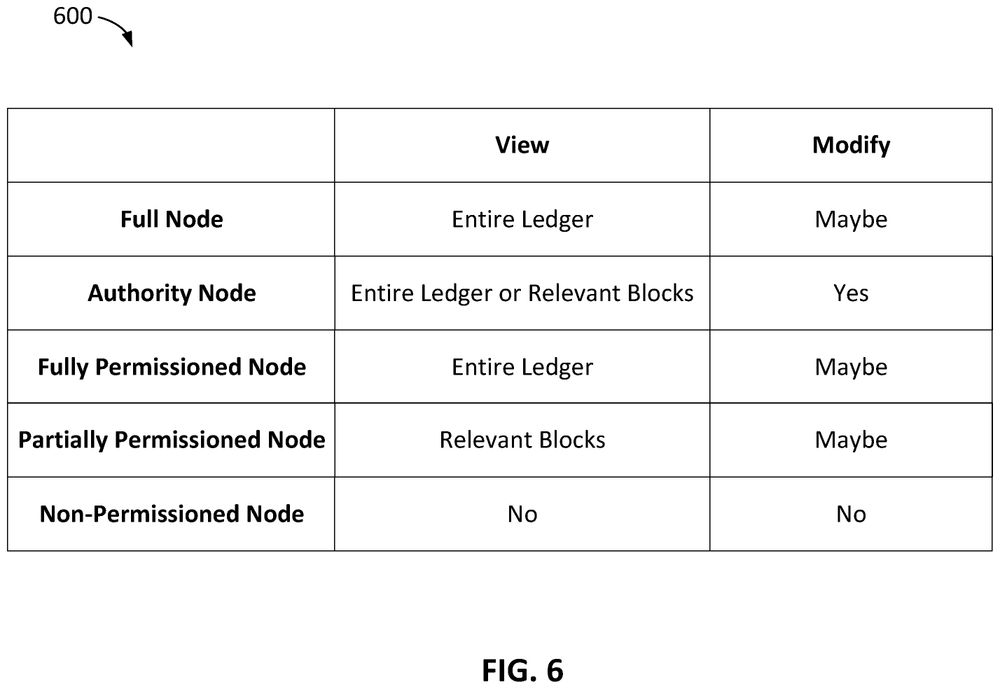

The blockchain module 122 may include a digital copy 124 of a shared ledger of the blockchain network. The shared ledger includes a plurality of blocks. Each block may include channel configurations (described below with respect to FIGS. 3B and 5A-5B) used in the blockchain network 109 and/or transaction records processed via the blockchain network 109. In some embodiments, the digital copy 124 of the shared ledger stored in the node A 104 may be only a portion of the entire shared ledger. For example, the copy 124 stored in the node A 104 may include only the blocks viewable to the node A 104 (described below with respect to FIG. 6).

The blockchain module 122 may include a smart contract module 126 that includes computer-executable instructions corresponding to one or more smart contracts. A smart contract is a set of computer-executable instruction that enables the execution and/or enforcement of an agreement between different parties. The smart contract instructions may include one or more triggers (i.e., pre-programmed conditions), that, when evaluated as true, cause further instructions to be executed, corresponding to one or more actions. Some smart contracts determine which action(s) from the one or more actions to performed based upon one or more decision conditions. Nodes on the network may subscribe to one or more data streams including data related to trigger conditions and/or decision conditions. Accordingly, the nodes may route the data streams to the smart contract module 126 so that the smart contracts stored thereon may process the data streams and detect that trigger/condition has occurred and/or analyze a decision condition to direct nodes to perform one or more actions.

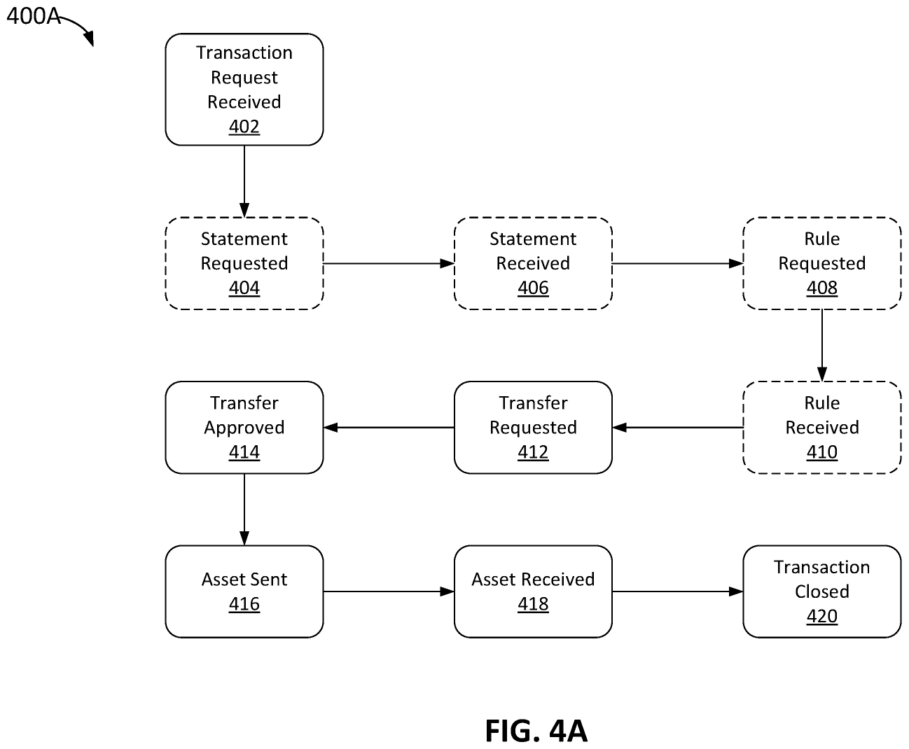

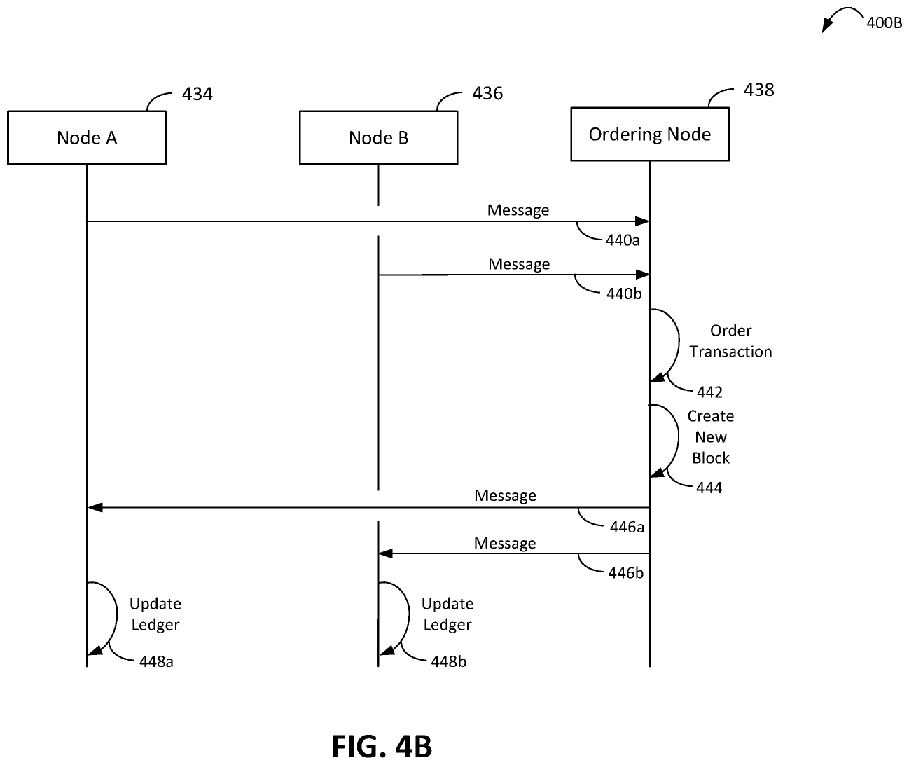

The smart contract module 126 may include a set of instructions for storing and updating a state of transaction based on triggers. For example, upon the node A 104 receiving an input event, the input event may trigger the smart contract to cause the node A 104 to perform certain actions, as will be discussed with respect to FIGS. 4A and 4B.

In some embodiments, the smart contract module 126 may be integrated into the ledger module 144. That is, the instructions and data of the smart contract may be stored as one or more blocks on the ledger, as will be described in detail below with respect to FIG. 3A.

The distributed file system module 128 may include instructions for storing and managing documents, such as transfer documents. The distributed file system module 128 also includes network protocols for implementing and/or accessing a decentralized network. The node A 104, the node B 106, and/or other nodes may be nodes of the decentralized network. In some embodiments, when the node A 104 generates or receives a document, the distributed file system module 128 may generate a unique content identifier (CID) for the document. The distributed file system module 128 may generate the CID using a hashing algorithm. In some embodiments, when the node A updates a document, such as a user signs a transfer document, the distributed file system module 128 may generate a new CID for the updated document and store both the original and the updated versions in the node A 104. The CIDs of documents may be shared and maintained on the decentralized network using the network protocols. As one example, the distributed file system is an Interplanetary File System (IPFS), and the decentralized network is an IPFS network. As another example the distributed file system is a BitTorrent system.

The node B 106 is a computing device associated with an entity B. The node B 106 may be structured similarly with or differently from the node A 104. The node B 106 depicted in FIG. 1 may include a processor 132 similar to the processor 112, a network interface 134 similar to the network interface 114, and a memory 136 similar to the memory 116.

The memory 136 may include a blockchain module 142 similar to the blockchain module 122 and a distributed file system module 148 similar to the distributed file system 128. The blockchain module 142 may include a digital copy 144 of the shared ledger of the blockchain network 109. In some embodiments, the copy 144 stored in the node B 106 may include only the blocks viewable to the node B 106 (described below with respect to FIG. 6). Accordingly, the copy 144 of the shared ledger maintained by the node B 106 may be different from the copy 124 maintained by the node A 104.

The blockchain module 142 may include a smart contract module 146, which may be configured in a similar manner as the smart contract module 126.

The blockchain network 109 may further include node C 108. Generally, node C 108 may be dedicated to receiving transactions (including state updates) from peer nodes (such as the node A 104 and the node B 106), ordering the transactions, and creating new blocks that includes the transactions.

Node C 108 may include a processor 172 similar to the processor 112, a network interface 174 similar to the network interface 114, and a memory 176 similar to the memory 116. The memory 176 may include an ordering service module 178. The ordering service module 178 may include instructions for ordering transactions and creating new blocks. The ordering service module 178 may also include instructions for performing consensus mechanisms described above. The ordering service module 178 may further include instructions for maintaining a ledger and a smart contract, similar to the modules 124 and 126 described above, respectively.

### Exemplary Graphical User Interfaces (GUIs)

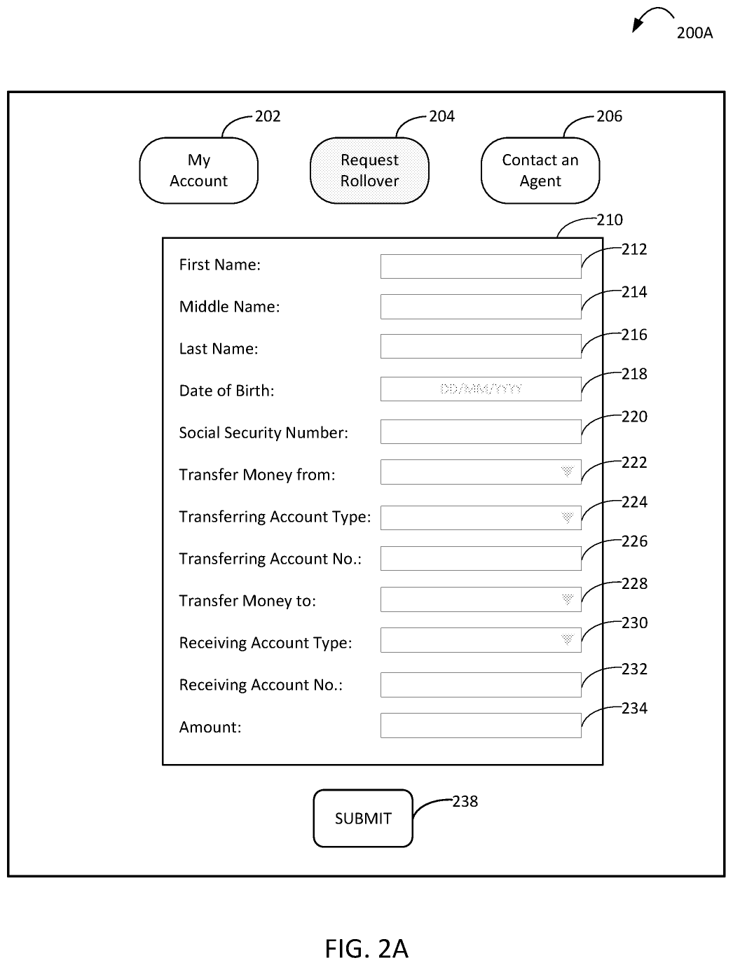

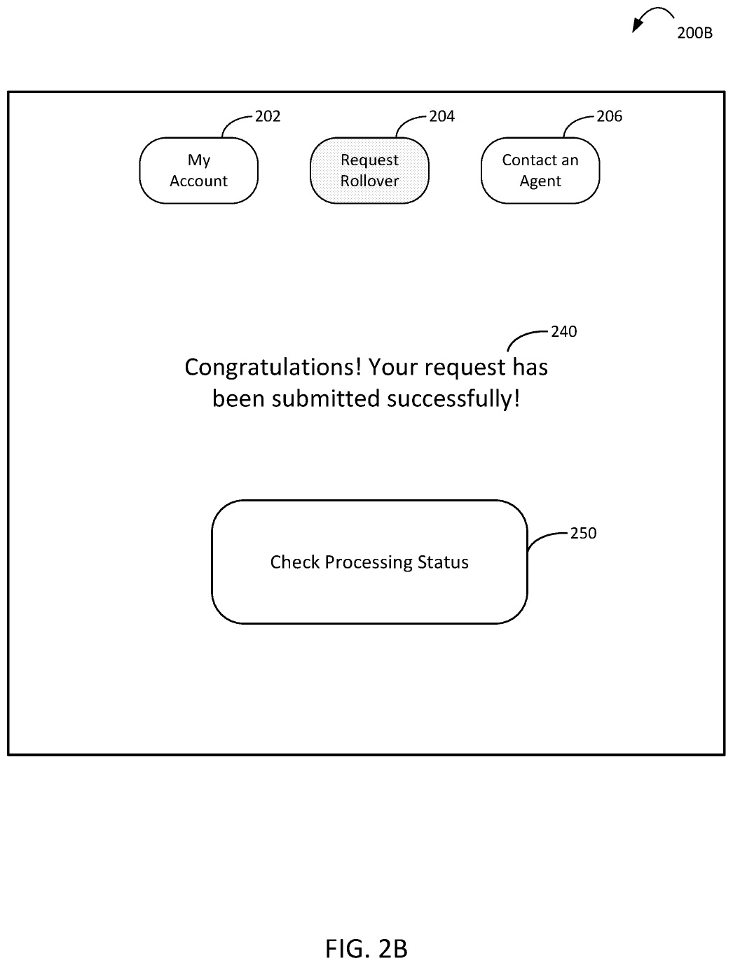

FIG. 2A depicts an exemplary GUI 200A of an application to request a transfer of asset from an entity B to an entity A, according to one embodiment. The application may be implemented with the instructions in the application module 162 of the user device 102. The application may be a desktop application, a mobile application, or a web-based application. The application may be run on a user device (e.g., the user device 102).

When a user wishes to request a transfer of asset from an entity B to an entity A, the user may sign in the application using user credentials, such as a user name and a password. The user may then initiate the request by interacting with selectable element “Request Rollover” 204. In response, the user device may present an electronic form 210 to allow the user to fill in relevant information for the request.

The user may fill in all information 212-226 manually. Alternatively, the user device may pre-fill some information based on the user's profile, such as the user's name 212-216 and the user's date of birth 218. The user may fill in the entity B 222 and the entity A 228 by typing or selecting the entities from a drop-down list prompted based on the user's input. The user may also fill in account types and account numbers with respect to each entity by typing or selecting from a drop-down list. The user may fill in the amount for the transfer request from a drop-down list, the maximum amount of which is the total amount that user has in the entity B.

After filling in all relevant information 212-234, the user may interact with selectable element “submit” 238 to submit the request.

Turning to FIG. 2B, after the user submitted the request, the user device may present a thread 240 to inform the user that the request has been submitted successfully. The user may interact with selectable element “Checking Processing Status” 250 to obtain a real-time status of the processing of the request.

In some embodiments, after the user submits the request, a node processing the request may cause a transfer document to be generated. The user device may receive the transfer document from the node. The user device may then present the transfer document to the user and prompt the user to sign the transfer document either physically or digitally. After the user signs the transfer document, the user device may transmit the signed transfer document to the node for further processing, as will be discussed with respect to FIGS. 4A and 4B.

### Exemplary Blockchain

FIGS. 3A and 3B depict an example rollover blockchain ledger 300 in accordance with various embodiments disclosed herein.

Referring to FIG. 3A, the rollover blockchain ledger 300 may include a plurality of blocks, including the blocks 302-310. Some blocks may have stored thereon a smart contract. The smart contract may include transaction records.

For example, when a node initializes a smart contract, the node may create a block 304 that includes the smart contract 320. The initial smart contract 320 may not include any transaction records but may provide formats for data of transaction records to be stored thereon.

After a node (such as the node A 104) receives a transfer transaction request, a node (such as the node C 108) may create a block including a transaction record associated with the transfer transaction request. The transaction record may indicate a state of the transfer transaction. For example, the state in block 322 is transaction request received. As an example, the state in block 324 is transfer requested. More details of updating the state of the transfer transaction will be described below with respect to FIGS. 4A and 4B.

Turning to FIG. 3B, a first block 302 of the rollover blockchain ledger 300, e.g., the genesis block, may have stored thereon a channel configuration 330. As described above, the channel configuration 330 may include network parameters 340, consortium information 342, consensus mechanism (not depicted), etc.

The consortium information 342 may include identifiers of nodes in the consortium at the time the genesis block 302 was created. The consortium information 342 may also include permission levels associated with each node in the consortium.

When the nodes in the rollover blockchain ledger 300 allow a new node to join the consortium, a node may cause a block 310 to be created, and include updated consortium information in the block 310. The updated consortium information may include an identifier of the newly joined node and its corresponding permission level.

More details of forming a consortium and adding a new node in the consortium will be described below with respect to FIGS. 5A-6.

### Exemplary Process for Transferring Retirement Assets

FIG. 4A depicts a state diagram 400A representing an exemplary computer-implemented method for transferring assets within a blockchain network, in accordance with various embodiments described herein. Each block in the state diagram 400A represents a state of a transfer transaction. When the transfer transaction created and/or updated to a new state, the nodes of the blockchain network create a new block, append the new block in their respective copy of ledger, and the new block indicates the new state. More details of a process for updating a state will be described with respect to FIG. 4B.

A node A (such as the node A 104) may determine a state of the states below based on an input event. The input event may be receiving a transaction request from a user device or an action performed by the node A in a previous state. An input event may trigger a smart contract of the node A to cause the node A to perform certain actions in a corresponding state. The node A may perform, unrelated to the smart contract, certain actions described below, or the smart contract may cause node to perform certain actions described below.

The state diagram 400A may begin when the node A receives a transaction request from a user device via an API. The node A may be associated with an entity A, such as a financial entity. The transaction request may be transferring a user's retirement asset from an entity B to the entity A. As defined above, the entity A may be a destination entity with respect to the transaction request. Correspondingly, the node A may be a destination node with respect to the transaction request. Similarly, the entity B may be a source entity with respect to the transaction request. Correspondingly, the node B may be a source node with respect to the transaction request.

The node A may create a transaction record for the transaction request, indicating the state of the transfer transaction as state 402 transaction request received. More specifically, The node A may cause a new block to be created, and the new block includes a smart contract, which indicates the state of the transfer transaction as state 402 transaction request received, such as the block 306 in the rollover blockchain ledger 300 in FIG. 3A.

When the transfer transaction is in state 402 transaction request received, the node A may request a statement associated with the transaction request. The statement may be a bank statement that shows the user owns the retirement asset to be transferred at the entity B. The node A may transmit the request for statements to the user device, so that the user may upload a statement in respond. Additionally or alternatively, the node A may transmit the request to the node B or another computing device associated with the entity B.

The node A may then update the state of the transfer transaction to state 404 statement requested. That is, the node A may cause a new block to be created, and the new block includes a smart contract, which indicates the state of the transfer transaction as state 404 statement requested.

When the transfer transaction is in state 404 statement requested, the node A may receive the statement from the user device or a computing device associated with the entity B (including the node B). The node A may then update the state of the transfer transaction to state 406 statement received. That is, the node A may cause a new block to be created, and the new block includes a smart contract, which indicates the state of the transfer transaction as state 406 statement received.

When the transfer transaction is in state 406 statement requested, the node A may request for transaction rules of the entity B. The node A may transmit the request to the node B or another computing device associated with the entity B. The transaction rules may define formal or substantive requirements for transaction requests to be submitted to the entity B. In some embodiments, the node A may further request transactions rules provided by governments, such as IRS regulations for retirement transfer requests. The node A may request such government rules from a database of the entity A, from a computing device associated with a government entity, or from a computing device associated with the entity B (including the node B) as part of the transaction rules of the entity B. The node A may then update the state of the transfer transaction to state 408 rule requested. That is, the node A may cause a new block to be created, and the new block includes a smart contract, which indicates the state of the transfer transaction as state 408 rule requested.

In some embodiments, states 404 and 406 described above may be omitted. For example, the node A may not need a statement to process the transaction request, so that states 404 and 406 may be omitted. In such embodiments, when the transfer transaction is in state 402 transaction request received, after the node A performs the steps described in states 402 and 406, except the steps for updating states, the node A may update the state of the transfer transaction to state 408 rule requested, instead of state 404 statement requested.

When the transfer transaction is in state 408 rule requested, the node A may receive the requested rules from the node B or other computing devices. The node A may then update the state of the transfer transaction to state 410 rule received. That is, the node A may cause a new block to be created, and the new block includes a smart contract, which indicates the state of the transfer transaction as state 410 rule received.

When the transfer transaction is in state 410 rule received, the node A may generate a transfer request based on the transaction request received from the user device. The node A may cause a transfer document to be generated based on the rules of the entity B and/or relevant government rules. The transfer document is compliant with the rules of the entity B. To this end, the node A may generate the transfer document. Alternatively, the node A may cause another computing device to generate the transfer document. In some embodiments, the node A may generate or cause another computing device to generate a CID for the transfer document using a hashing algorithm.

In some embodiments, the node A may digitally sign the transfer request and/or transfer document with its private key. In some embodiments, the node A may transmit the transfer document to the user device to allow the user to digitally sign the document via an API. The node A may then receive the transfer document with the user's signature from the user device via the API.

The node A may then transmit the transfer request and the transfer document to the node B for approval. In some embodiments, simultaneously or after the transmission, the node A may grant the node B permission to access the user's profile and/or account information such that the node B may obtain necessary information for the purposes of approving the transfer request and/or the transfer document.

The node A may then update the state of the transfer transaction to state 412 transfer requested. That is, the node A may cause a new block to be created, and the new block includes a smart contract, which indicates the state of the transfer transaction as state 412 transfer requested.

In some embodiments, states 408 and 410 described above may be omitted. For example, the node A may have stored thereon transaction rules of the entity B and does not need to request for the transaction rules, so that states 408 and 410 may be omitted. In such embodiments, when the transfer transaction is in state 406 statement received, after the node A performs the steps described in states 406 and 410, except the steps for updating states, the node A may update the state of the transfer transaction to 412 transfer requested, instead of state 408 rule requested.

In some embodiments, as indicated above, states 404 and 406 may also be omitted. In the embodiments where states 404-410 are omitted, when the transfer transaction is in state 402 transaction request received, after the node A performs the steps described in states 402 and 410, except the steps for updating states, the node A may update the state of the transfer transaction to 412 transfer requested, instead of state 404 statement requested.

When the transfer transaction is in state 412 transfer requested, the node A may receive a message from the node B indicating that the transfer request and/or the transfer document are approved. To this end, the node B may verify that the transfer document is compliant with the rules of entity. In some embodiments, the node B may verify the private key signed on the transfer request and/or the transfer document with a public key of node A. Upon successful verification of the transfer request and the transfer document, the node B may transmit a message to the node A indicating the approval.

The node A may then update the state of the transfer transaction to state 414 transfer approved. That is, the node A may cause a new block to be created, and the new block includes a smart contract, which indicates the state of the transfer transaction as state 414 transfer approved.

When the transfer transaction is in state 414 transfer approved, the node A may receive a message from the node B indicating that the entity B has sent the retirement asset to the entity A. To this end, when the entity B is sending the retirement asset to the entity A, such as via a wire system, the node B may transmit a message to the node A to indicate such actions. The node A may then update the state of the transfer transaction to state 416 asset sent. That is, the node A may cause a new block to be created, and the new block includes a smart contract, which indicates the state of the transfer transaction as state 416 asset sent.

When the transfer transaction is in state 416 asset sent, the node A may confirm that the entity A has received the retirement asset. To this end, the node A may access a database of the entity A having transaction records stored thereon. The node A may confirm that there is a transaction record indicates that the entity A has received the retirement. The node A may then update the state of the transfer transaction to state 418 asset received. That is, the node A may cause a new block to be created, and the new block includes a smart contract, which indicates the state of the transfer transaction as state 418 asset received.

When the transfer transaction is in state 418 asset received, the node A may confirm that the retirement asset has been added to an account of the user with the entity. To this end, the node A may access the user's account information at the entity A, and confirm that the entity A has added the retirement asset to the user's account. The node A may then update the state of the transfer transaction to state 420 transaction closed. That is, the node A may cause a new block to be created, and the new block includes a smart contract, which indicates the state of the transfer transaction as state 420 transaction closed.

When the transfer transaction is in state 418 asset received, the node A may transmit, to the user device, a notice of receipt of the retirement asset.

In some embodiments, a user may inquire a status of the transaction request, such as via an API (e.g., selecting the selectable element 250). The user device may transmit a message to the node A indicating the inquiry request. The node A, responsive to receiving the message, may retrieve a current state of the transaction (i.e., a real-time status of the user's transaction request) from the latest block that indicates a state of the transaction. The node A may then generate a message indicating a current state of the transaction and then transmit the message to the user device. In this way, the user may obtain a real-time status of the user's transaction request.

It should be understood that although in the description above the node A performs all the updates of the transaction states and certain other actions, other nodes (such as the node B) may perform similar actions.

FIG. 4B is an example sequence diagram 400B that illustrates a process for updating a state of a transaction.

A node A 434 (such as the node A 104) of the blockchain network may receive an input event. The node A 434 may receive the input event from a user device (such as the user device 102), such as receiving transfer transaction request as described with respect to state 402. The node A may receive the input event from a previous event. For example, the node A 434 may perform certain actions and then update the state of the transaction. The action of the update may be an input event that moves the state of the transaction to a next state, such as the scenarios described with respect to states 404-420. Other nodes (such as the node B 436) of the blockchain network may receive an input event and update the state of the transaction accordingly.

When the node A 434 and/or the node B 436 receive an input event, the node A 434 and/or the node B 436 may process the input event to determine a current transfer state of the transfer transaction. After determining the current state, the node A 434 and/or the node B 436 may perform relevant steps in the current state, as described above with respect to FIG. 4A.

The steps may include a step to update the state of the transfer transaction. To update the state, the node A 434 and/or the node B 436 may transmit (440a and/or 440b) a message to an ordering node 438, indicating the update of the state. The ordering node 438 may order (442) the update and other transactions it received and organize them into batches. In some embodiments, before ordering (442) the update, the ordering node 438 may verify the update of the state based on the consensus mechanism used in the blockchain network. In some embodiments, the consensus mechanism is RAFT or PBFT.

After ordering (442) the transactions, the ordering node 438 may create (444) a new block and include a batch of transactions in the new block. The new block may include a copy of a smart contract. The smart contract may include a record of the transfer transaction that indicates a state of the transfer transaction, such as the blocks 322 and 324.

The ordering node 438 may then transmit (446a and/or 446b) messages to the node A 434 and/or the node B 436, respectively. The message may indicate the new block. Upon receiving the messages, the node A 434 and/or the node B 436 may update (448a and/or 448b) their respective copies of ledger to append the new block to the ledger.

Upon the nodes updating their copies of ledger, the state of the transfer transaction is updated accordingly.

### Exemplary Process of Forming Consortium Blockchain Network

The blockchain network disclosed herein may be a consortium blockchain network. A consortium blockchain network is network that is operated by a group of entities that have agreed to work together to maintain the blockchain. With respect to the consortium blockchain network disclosed herein, the group of entities includes at least an entity A and an entity B. Accordingly, at least a node A associated with the entity A and a node B associated with the entity B are in the consortium blockchain network.

When forming the consortium, the representatives of the entity A, the entity B, and other entities (if any) may discuss and agree on policies and network parameters to be used in the consortium blockchain network. The policies may provide what entities are in the consortium, the permission levels of the nodes of the respective entities, the criteria for allowing a new entity to join the consortium and determining its corresponding permission level, the process of proposing and approving a transaction, the process of creating and adding a new block to the blockchain. The network parameters may define the hardware, software, and/or communication protocols used by the nodes.

After determining the policies and network parameters, the nodes of the entities in the consortium may set up a blockchain channel. The channel is a mechanism that provides a private layer of communication. The nodes may communicate use the blockchain channel. To set up the channel, the nodes may create a configuration block (such as the block 302) including channel configurations, the channel configurations include instructions for implementing the policies and network parameters agreed by the entities. The configuration block may then be the first block (e.g., a genesis block) of the blockchain (or the shared ledger). In some embodiments, the genesis block is created bilaterally. That is, the nodes work together to create the genesis block. In other embodiments, the genesis block is created unilaterally by one node, and other nodes are invited to join the network and add the genesis block to their copy of the blockchain. Once the genesis block including the channel configuration is created and shared by all nodes in the blockchain, the channel is set up.

It should be understood the term “configuration block” may refer to a block including channel configurations, or a block including transaction records and channel configurations. However, a configuration block is not structured differently from a transaction block described above.

Referring to FIG. 5A, when a particular entity wishes to join the consortium, a particular node associated with the particular entity may transmit (512a, 512b) a request to the blockchain network. If the policies and rules in the channel configuration provide that one or more specific nodes shall process the request for joining the consortium, the request will be transmitted to the one or more specific nodes. Otherwise, the request will be transmitted to all nodes of the network. In the scenario depicted in FIG. 5A, the channel configuration requires the request to be transmitted to the processing node 504 and a peer node 506. The processing node 504 and the peer node 506 may be any node of the blockchain network that are associated with respective entities, such as the node A or the node B.

After receiving the request to join the consortium blockchain network, the processing node 504 and the peer node 506 may react independently to the request based on the policies in the channel configuration. If the nodes determine that the particular node 502 and/or the particular entity meet the criteria to join the network, the nodes may endorse (514a, 514b) the request. Additionally or alternatively, the processing node 504 and/or the peer node 506 may present the request to representatives of their respective entities, and allow the representatives to approve the request manually. In some embodiments, the nodes may sign the endorsement with their respective private keys.

In some embodiments, the processing node 504 and the peer node 506 may determine a permission level associated with the particular node independently based on the policies and rules in the channel configuration described below with respect to FIG. 6.

The channel configuration may provide which node collect the endorsement and propose the request to the ordering nodes. For example, the node may be selected based on permission levels or certain algorithms. In the scenario depicted in FIG. 5A, the processing node 504 shall perform these actions. Accordingly, the peer node 506 may transmit (516) a message to the processing node 504 indicating an endorsement of the request and optionally with the determined permission level associated with the particular node. In response, the processing node 504 may determine that a required number of endorsements (and optionally identically determined permission level) are received and may optionally authenticate the endorsements with the public keys of the respective endorsing nodes.

The processing node 504 may then generate (522) a proposal indicating to register the particular node with the blockchain network. The proposal may include an identifier of the particular node 502, information of the particular entity, the signatures of the endorsing nodes, and/or a permission level associated with the particular node.

The processing node 504 may transmit (524) the proposal to one or more ordering nodes 508. Each of the ordering nodes may verify (526) the proposal independently, including verifying the that the proposal does not conflict with the channel configuration in existing blocks, the process of generating the proposal is consistent with the policies of the blockchain network, and optionally authenticating the proposal with the public keys of the processing node 504 and the peer node 506, respectively.

In some embodiments, for each of the ordering nodes that verifies the proposal successfully (or “endorsing” the proposal), the ordering nodes may generate (428) a response. The response may indicate an identifier of the particular node 502 to be registered with the blockchain network, information of the particular entity, and/or a permission level associated with the particular node 502. The ordering nodes 508 may sign the response with their respective private keys to indicate their respective endorsements.

The ordering nodes may then transmit (532) the responses to the processing node 504. The processing node 504 may verify (532) that the response is consistent with the proposal and transmit (533) to the ordering nodes 508 a message indicating the successful verification. Upon successfully verifying the transaction results, the processing node 504 may transmit (533) a message indicating the successful verification to the ordering nodes 508. The messages may include the digital signatures of the ordering nodes endorsing the proposal.

Upon receiving the message, one of the ordering nodes 508 may create (534) a configuration block (such as the block 304) in a similar manner described with respect to FIG. 4B and include, in the configuration block, updates to the channel configurations that effect the registration of the particular node with the blockchain network. In some embodiments, the ordering node creates (534) the configuration block only after authenticating the message with the public keys of the respective endorsing ordering nodes keys and/or verifying that the number of digital signatures is more than a required number (such as a half of the total number of the ordering nodes).

The one ordering node may then transmit (536a, 536b) messages to the processing node 504, the peer node 506, and other nodes in the blockchain network (including the other ordering nodes), respectively. The messages may indicate the configuration block. The source nodes, such as the other ordering nodes, may verify the configuration block, which may include verifying the that the updates to the channel configurations in the configuration block do not conflict with the channel configurations in their respective copy of blockchain, the process of creating block is consistent with the configuration and policies of the blockchain network, and/or authenticating the transactions with the public key of the ordering node. If a required number of the source nodes (such as a half of all the source nodes) verify the transactions in the configuration block successfully, the ordering nodes may transmit (536b, 536a) a message to the processing node 504 and the peer node 506 to indicate an approval of the configuration block. The processing node 504, the peer node 506, and the source nodes in the blockchain network may then update (538a, 538b) their respective copy of ledger by appending the configuration block to it.

Upon updating the ledger, the particular node 502 is registered with the consortium blockchain network successfully. The processing node 504 may transmit (540) a message indicating the successful registration of the particular node.

It should also be understood that, although some steps are explicitly described as optional, any of the steps in FIGS. 5A-5B may be optional, even if they are not explicitly described as such.

FIG. 6 illustrates exemplary permission levels of different nodes in the blockchain network.

Some node categories are determined based on their functionality in the blockchain network, such as the full node and the ordering node.

A full node may be configured to download and store the entire shared ledger of the blockchain network. A full node may also be configurated to perform a variety of critical tasks, including transaction and block validation, relaying data to other nodes, and upholding consensus rules. As required by its functionality, a full node may view the entire shared ledger. If the full node is further configured to create new blocks and append new blocks to the shared ledger, in which case the full node is also an ordering node (described below), the full node may also modify the shared ledger.

An ordering node may be configured to verify transactions, creating new blocks, compiling transactions into the new blocks, verifying new blocks, and appending new blocks to the share ledger. An ordering node may be configured to view the entire ledger or relevant blocks only. A relevant block to an ordering node is a block including transactions relevant to a pending transaction that the ordering node is processing. For example, if an ordering node is processing a transaction request to transfer an asset of a user from an entity B to an entity A, a relevant block may include a historical transaction in which the entity B is a transferor entity and the user's asset is involved. The ordering node would need to view such relevant blocks to ensure that the requested asset has not been transferred to other entities or people already.

Some node categories are determined based on features of corresponding entities, such as fully permissioned node, a permissioned node, and a non-permissioned node. The features may include a type of the entity, a size of the entity, a credit rating of the entity, a role of the entity in a transaction, etc.

A node of an entity with outstanding features may be fully permissioned. For example, if an entity is a major financial institute with an AAA credit rating, a node of the entity may be fully permissioned. As another example, if an entity is a founding entity of the consortium, a node of the entity may be fully permissioned. A fully permissioned node may be configured to view the entire shared ledger. Depending on the channel configurations, a fully permissioned node may be configured to modify the shared ledger by creating a new block, including in the new block a transaction in which the associated entity is a party, and appending the new block to the shared ledger. If a fully node is configured to be incapable of modifying the shared ledger, the node may transmit a transaction proposal to the ordering nodes and cause the ordering nodes to modify the shared ledger.

By default, a node of a regular entity is a partially permissioned node. A partially permissioned node may be configured to view relevant blocks only. A relevant block includes a block that includes transactions in which the corresponding entity is a party or a third party. If a partially permissioned node needs to verify a transaction request involving a particular entity, the node may be configured to view blocks including transactions in which the particular entity is a party or a third party.

Consistent with such permission level configurations, the copy of the shared ledger maintained by a partially permissioned node is not a complete copy of the shared ledger. Rather, the copy maintained by the partially permissioned node includes the blocks viewable to the partially permissioned node only. Advantageously, such permission configurations may preserve privacy of the entities in the consortium without sacrificing the trustworthiness of the transaction processes.

A node of an entity with certain features may be non-permissioned. For example, if an entity has been associated with illegal transactions, a node of the entity may be non-permissioned. A non-permissioned node may not view any block of the shared ledger or modify the shared ledger.

A full node or an ordering node may be a node dedicated to its respective functionalities and are not associated with any entity. Alternatively, a full node or an authority may be a peer node associated with a particular entity. In such scenarios, a node may be in multiple node categories in FIG. 6. For example, a node may be both an ordering node and a partially permissioned node. A permission level of such a node may be determined based on its role in a particular process. For example, if the node is acting as an ordering node in a particular process, its permission level in the particular process may be in accordance with its role as an ordering node. In another example, if the node is acting as a peer node in a particular process, its permission level may be partially permissioned.

The policies or rules for determining node permission levels described above may be stored as instructions in the channel configurations. The permission levels of the nodes may be modified automatically if the relevant features of corresponding entities change.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, and/or may be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for evaluation properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computer-implemented method for managing retirement asset transfers within a private blockchain network, comprising:
processing, by a destination node associated with a destination entity, an input event by:
generating a transfer request based on a transaction request,
causing a transfer document to be generated,
transmitting, to a source node associated with a source entity, the transfer request and the transfer document, and
updating a current transfer state to transfer requested;
processing, by the destination node, a transfer requested input event by:
receiving, from the source node, a message indicating that transaction request is approved, and
updating the current transfer state to transfer approved;
processing, by the destination node, a transfer approved input event by:
receiving a message indicating that the source entity has sent the retirement asset to the destination entity, and
updating the current transfer state to asset sent;
processing, by the destination node, an asset sent input event by:
confirming that the destination entity has received the retirement asset, and
updating the current transfer state to asset received;
processing, by the destination node, an asset received input event by:
confirming that the retirement asset has been added to an electronic account of a user associated with the transaction request, and
updating the current transfer state to closed; and
processing, by the destination node, a transaction closed input event by transmitting, to a user device, a notice of receipt of the retirement asset.

2. The method of claim 1, wherein causing the transfer document to be generated includes:
causing, by the destination node, a computing device to generate the transfer document, the transfer document compliant with a set of rules associated with the source entity.

3. The method of claim 1, further comprising:
granting, by the destination node to the source node, a permission to access a user profile associated with the transaction request.

4. The method of claim 1, further comprising:
transmitting, by the destination node to the user device, the transfer document to allow the user to sign the transfer document; and
receiving, by the destination node from the user device via an API, the transfer document with a signature of the user.

5. The method of claim 1, wherein transmitting the transfer document to the source node includes:
transmitting, by the destination node, the transfer document signed with a private key associated with the destination node to cause the source node to authenticate the transaction request using a public key associated with the destination node.

6. The method of claim 1, wherein a block is configured to be viewable by a fully permissioned node set including the destination node and the source node, and not viewable by a non-permissioned node set including one or more nodes of a plurality of nodes that maintain the blockchain.

7. The method of claim 1, wherein the blockchain network is a consortium blockchain network, the method further comprising:
receiving, by the destination node from a particular node, a request to register with the consortium blockchain network;
determining, by the destination node, that the particular node satisfies a set of consortium rules;
responsive to the determination, causing, by the destination node, a configuration block to be created, the configuration block includes configuration updates that effect a registration of the particular node with the consortium blockchain network; and
appending, by the destination node, the configuration block including the transaction to a copy of a shared ledger maintained by the destination node.

8. The method of claim 1, comprising:
receiving, by the destination node from the user device, an inquiry request;
generating, by the destination node based on the current transfer state, a message indicating a real-time status of processing transaction request; and
transmitting, by the destination node to the user device, the message.

9. The method of claim 1, comprising:
causing a content identifier (CID) associated with the transfer document to be generated by a distributed file system using a hashing algorithm.

10. The method of claim 1, wherein at least one of updating the current transfer state includes:
transmitting a message indicating the update of the current transfer state to an ordering node; and
causing the ordering node to verify the update of the current transfer state using a Raft or Practical Byzantine Fault Tolerance (PBFT) consensus mechanism.

11. The method of claim 1, wherein the input event is a transaction request received input event.

12. The method of claim 1, wherein the input event is a rule received input event, the method further comprising:
processing, by the destination node, a transaction request received input event by:
requesting a statement associated with the transaction request, and
updating the current transfer state to statement requested;
processing, by the destination node, a statement requested input event by:
receiving the statement associated with the transaction request, and
updating the current transfer state to statement received;
processing, by the destination node, a statement received input event by:
requesting transfer rules of the source entity, and
updating the current transfer state to rule requested;
processing, by the destination node, a rule requested input event by:
receiving the transfer rules of the source entity, and
updating the current transfer state to rule received.

13. A computer system for managing retirement asset transfers within a private blockchain network, comprising:
a destination node; and
a source node,
wherein the blockchain network is maintained by a plurality of nodes including the destination node associated with a destination entity and the source node associated with a source entity,
the destination node including:
one or more processors; and
a memory having stored thereon a set of computer-executable instructions that, when executed by the processors, cause the processors to:
receive, by the destination node, an input event corresponding to a transaction request of transferring a retirement asset from the source entity to the destination entity,
wherein the input event includes a current transfer state corresponding to one of a plurality of transaction states, and
wherein the current transfer state corresponds to the transaction request of the retirement asset;
until the current transfer state is transaction closed:
process, via one or more processors of the destination node, the input event to determine the current transfer state;
when the current transfer state is transaction request received:
generate a transfer request based on the transaction request,
cause a transfer document to be generated,
transmit, to the source node, the transfer request and the transfer document, and
update the current transfer state to transfer requested,
when the current transfer state is transfer requested:
receive, from the source node, a message indicating that transaction request is approved, and
update the current transfer state to transfer approved,
when the current transfer state is transfer approved:
receive a message indicating that the source entity has sent the retirement asset to the destination entity, and
update the current transfer state to asset sent,
when the current transfer state is asset sent:
confirm that the destination entity has received the retirement asset, and
update the current transfer state to asset received,
when the current transfer state is asset received:
confirm that the retirement asset has been added to an account of a user associated with transaction request, and
update the current transfer state to closed, and
when the current transfer state is transaction closed:
transmit, to a user device, a notice of receipt of the retirement asset.

14. The computer system of claim 13, wherein to cause the transfer document to be generated, the set of computer-executable instructions, when executed by the processors, causes the processors to:
Cause a computing device to generate the transfer document, the transfer document compliant with a set of rules associated with the source entity.

15. The computer system of claim 13, wherein the set of computer-executable instructions, when executed by the processors, causes the processors to:
granting, to the source node, a permission to access a user profile associated with the transaction request.

16. The computer system of claim 13, wherein the set of computer-executable instructions, when executed by the processors, causes the processors to:
transmit, to the user device, the transfer document to allow the user to sign the transfer document; and
receive, from the user device via an API, the transfer document with a signature of the user.

17. The computer system of claim 13, wherein to transmit the transfer document to the source node, the set of computer-executable instructions, when executed by the processors, causes the processors to:
transmit the transfer document signed with a private key associated with the destination node to cause the source node to authenticate the transaction request using a public key associated with the destination node.

18. The computer system of claim 13, wherein a block is configured to be viewable by a fully permissioned node set including the destination node and the source node, and not viewable by a non-permissioned node set including one or more nodes of a plurality of nodes that maintain the blockchain.

19. The computer system of claim 13, wherein the blockchain network is a consortium blockchain network, and wherein the set of computer-executable instructions, when executed by the processors, causes the processors to:
receive, from a particular node, a request to register with the consortium blockchain network;
determine that the particular node satisfies a set of consortium rules;
responsive to the determination, cause a configuration block to be created, the configuration block includes configuration updates that effect a registration of the particular node with the consortium blockchain network; and
append the configuration block including the transaction to a copy of a shared ledger maintained by the destination node.

20. A computer readable storage medium having stored thereon a set of non-transitory computer readable instructions for managing retirement asset transfers within a private blockchain network, the set of non-transitory computer readable instructions, when executed, cause a destination node within the blockchain network to:
receive an input event corresponding to a transaction request of transferring a retirement asset from a source entity to a destination entity, wherein the destination node is associated with the destination entity,
wherein the input event includes a current transfer state corresponding to one of a plurality of transaction states, and
wherein the current transfer state corresponds to the transaction request of the retirement asset;
until the current transfer state is transaction closed:
process the input event to determine the current transfer state;
when the current transfer state is transaction request received:
generate a transfer request based on the transaction request,
cause a transfer document to be generated,
transmit, to a source node associated with the source entity, the transfer request and the transfer document, and
update the current transfer state to transfer requested,
when the current transfer state is transfer requested:
receive, from the source node, a message indicating that transaction request is approved, and
update the current transfer state to transfer approved,
when the current transfer state is transfer approved:
receive a message indicating that the source entity has sent the retirement asset to the destination entity, and
update the current transfer state to asset sent,
when the current transfer state is asset sent:
confirm that the destination entity has received the retirement asset, and
update the current transfer state to asset received,
when the current transfer state is asset received:
confirm that the retirement asset has been added to an account of a user associated with the transaction request, and
update the current transfer state to closed, and
when the current transfer state is transaction closed:
transmit, to a user device, a notice of receipt of the retirement asset.
